(19) United States
(12) Patent Application Publication
(10) Pub. No.: US 2022/0034642 A1
(43) Pub. Date: Feb. 3, 2022

(54) ROTARY ANGLE DETECTING DEVICE

(71) Applicant: TDK TAIWAN CORP., Taoyuan City (TW)

(72) Inventors: Wei-Kuang TENG, Taoyuan City (TW); Po-Sung YAO, Taoyuan City (TW)

(21) Appl. No.: 16/944,576

(22) Filed: Jul. 31, 2020

(51) Int. Cl. G01B 7/30; G01D 5/16

(52) U.S. Cl. CPC G01B 7/30; G01D 5/16

(57) ABSTRACT

A rotary angle detecting device is provided, including a fixed portion, a rotary module, a sensing module, and a permeability member. The rotary module includes a rotary shaft pivotally connected to the fixed portion, and can rotate around a main axis relative to the fixed portion. The sensing module is configured to detect the motion state of the rotary shaft relative to the fixed portion. The sensing module includes a magnetic force sensor and a magnetic member corresponding to the magnetic force sensor. The magnetic member can rotate relative to the magnetic force sensor. The permeability member is disposed between the sensing module and the rotary module.

### BACKGROUND OF THE INVENTION

### Field of the Invention

The application relates in general to a rotary angle detecting device, and in particular, to a rotary angle detecting device having a magnetic force sensor.

### Description of the Related Art

An encoder is an electro-mechanical device that converts the angular position or motion of a shaft or axle to analog or digital output signals. The encoder is used in a wide range of applications that require precisely control in position or speed, for example, including industrial controls, robotics, photographic lenses, and computer input devices (such as mice and trackballs).

A common encoder uses optical method to measure, such as respectively disposing an optical source and an optical sensor on opposite sides of a rotary disc having at least one hole. However, when the encoder is required to be miniaturized, it is hard to assemble the components used in this method into the encoder, and the accuracy of measurement may be reduced. Therefore, how to address the aforementioned problem has become an important issue.

### BRIEF SUMMARY OF INVENTION

To address the deficiencies of conventional products, an embodiment of the invention provides a rotary angle detecting device, including a fixed portion, a rotary module, a sensing module, and a permeability member. The rotary module includes a rotary shaft pivotally connected to the fixed portion, and can rotate around a main axis relative to the fixed portion. The sensing module is configured to detect the motion state of the rotary shaft relative to the fixed portion. The sensing module includes a magnetic force sensor and a magnetic member corresponding to the magnetic force sensor. The magnetic member can rotate relative to the magnetic force sensor. The permeability member is disposed between the sensing module and the rotary module.

In some embodiments, the rotary module further comprises a bearing member disposed on the fixed portion, and the shaft axis is pivotally connected to the fixed portion via the bearing member. The bearing member is made of metal with weak permeability or non-metallic material. The permeability member is disposed between the bearing member and the magnetic force sensor.

In some embodiments, the magnetic member is disposed between the magnetic force sensor and the permeability member. The rotary module further comprises a magnetic member base affixed to the rotary axis, and the magnetic member is disposed on the magnetic member base. As seen from a direction perpendicular to the main axis, the magnetic member base and the magnetic member at least partially overlap. In some embodiments, the permeability member and the magnetic member base are integrally formed as one piece.

In some embodiments, the rotary angle detecting device further comprises an additional permeability member surrounding the magnetic member. The magnetic field lines inside the magnetic member are perpendicular to the main axis. In some embodiments, the magnetic member is a multipole magnet, and the magnetic field lines inside the magnetic member are parallel to the main axis.

In some embodiments, the rotary angle detecting device further comprises a circuit assembly and a plurality of supporting members. The circuit assembly comprises a plurality of connecting portions, and the supporting members correspond to the connecting portions. The supporting members connect the fixed portion to the circuit assembly, wherein the connection lines between the connecting portions form a close pattern, and the close pattern does not have rotational symmetry relative to the main axis.

In some embodiments, the circuit assembly comprises a circuit board, a connecting terminal, and a plurality of electronic members. The circuit board has a cutting portion, a plurality of testing circuits, and a plurality of recesses, wherein at least one testing circuit is adjacent to the cutting portion, an electrical connecting opening of the connecting terminal faces the main axis, and the recesses are formed on the edge of the circuit board. The magnetic force sensor and one of the electronic members are disposed on the circuit board, and the circuit board is disposed between the magnetic force sensor and this electronic member. The magnetic force sensor and another one of the electronic members are disposed on the same surface of the circuit board, wherein this electronic member and the magnetic member do not overlap as seen from the axis, and this electronic member and the magnetic member at least partially overlap as seen from the direction perpendicular to the main axis. The thickness of each of the aforementioned electronic members is greater than the thickness of the magnetic force sensor.

In some embodiments, the rotary shaft further comprises a depression portion, and at least a portion of the magnetic member is disposed in the depression portion. The rotary shaft is made of metal with weak permeability or non-metallic material. In some embodiments, the rotary shaft is made of metal, and the permeability member is disposed between the magnetic member and the rotary shaft.

### BRIEF DESCRIPTION OF DRAWINGS

The invention can be more fully understood by reading the subsequent detailed description and examples with references made to the accompanying drawings, wherein:

FIG. 1 is a schematic diagram of a rotary angle detecting device according to an embodiment of the invention;

FIG. 2 is an exploded-view diagram of a rotary angle detecting device according to an embodiment of the invention;

FIG. 3 is a cross-sectional view of a rotary angle detecting device according to an embodiment of the invention;

FIG. 4 is a schematic diagram of a magnetic member base according to an embodiment of the invention;

FIG. 5A is a schematic diagram of a circuit assembly according to an embodiment of the invention;

FIG. 5B is a schematic diagram of the circuit assembly in another view according to an embodiment of the invention;

FIG. 6A is a schematic diagram of a magnetic force sensor according to an embodiment of the invention, wherein the magnetic field direction of the pin layer is opposite to the magnetic field direction of the free layer;

FIG. 6B is a schematic diagram of the magnetic force sensor according to an embodiment of the invention, wherein the magnetic field direction of the pin layer is different from the magnetic field direction of the free layer;

FIG. 6C is a schematic diagram of the magnetic force sensor according to an embodiment of the invention, wherein the magnetic field direction of the pin layer is the same as the magnetic field direction of the free layer;

FIG. 7 is a schematic diagram of the magnetic force sensor and the magnetic member according to an embodiment of the invention;

FIG. 8 is a schematic diagram of the magnetic force sensor and the magnetic member according to another embodiment of the invention;

FIG. 9 is a schematic diagram of a rotary angle detecting device according to another embodiment of the invention;

FIG. 10 is a schematic diagram of a rotary angle detecting device according to another embodiment of the invention; and

FIG. 11 is a circuit connection schematic diagram of a circuit assembly, a magnetic force sensor, and external components according to some embodiments of the invention.

### DETAILED DESCRIPTION OF INVENTION

The making and using of the embodiments of the rotary angle detecting device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

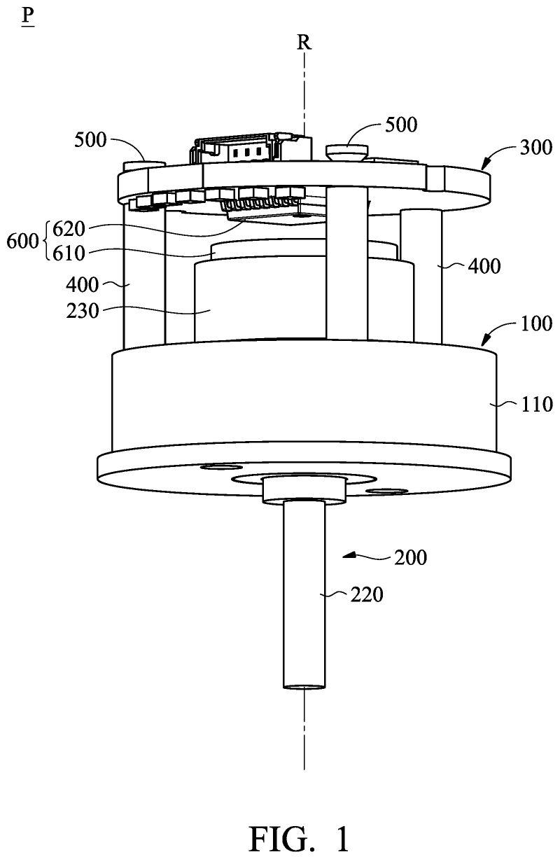

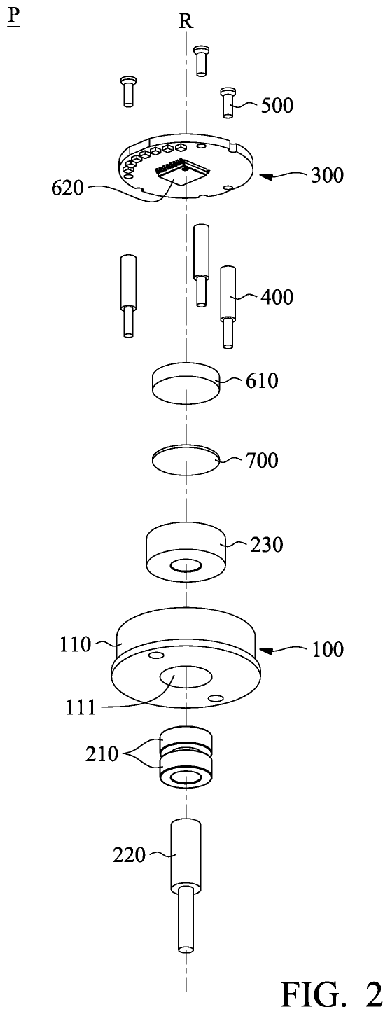

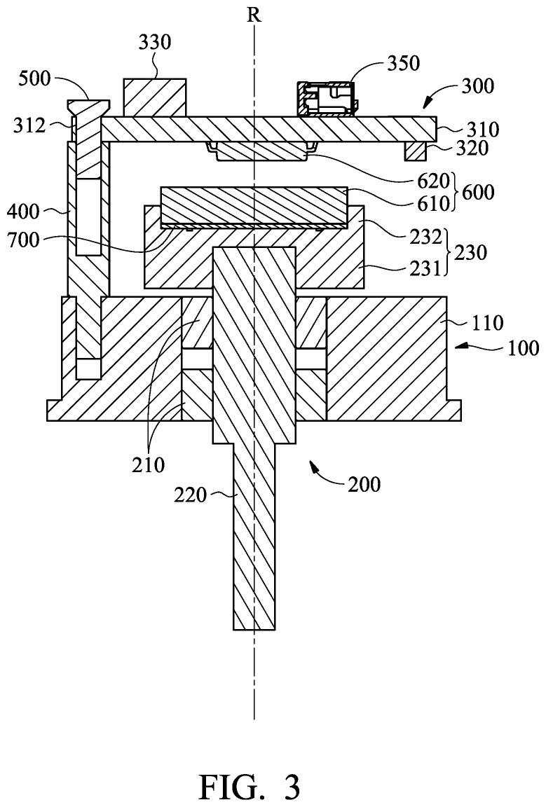

FIG. 1 is a schematic diagram of a rotary angle detecting device P according to an embodiment of the invention, FIG. 2 is an exploded-view diagram of the rotary angle detecting device P, and FIG. 3 is a cross-sectional view of the rotary angle detecting device P. Referring to FIGS. 1-3, the rotary angle detecting device P primarily includes a fixed portion 100, a rotary module 200, a circuit assembly 300, a plurality of supporting members 400, a plurality of locking members 500, a sensing module 600, and a permeability member 700.

The fixed portion 100 includes a cylindrical main body 110. The rotary module 200 includes at least one bearing member 210, a rotary shaft 220, and a magnetic member base 230. A through hole 111 is formed on the center of the main body 110 of the fixed portion 100. The bearing member 210 can be accommodated in the through hole 111 and affixed to the main body 110. The rotary shaft 220 passes through the hole at the center of the bearing member 210, so that the rotary shaft can be pivotally connected to the main body 110 of the fixed portion 100 via the bearing member 210.

In this embodiment, the rotary module 200 includes two bearing members 210 separately disposed in the through hole 111 of the main body 110. Therefore, the rotary shaft 220 can be ensured to extend along a main axis R, and the inclination of the rotary shaft 220 can be prevented.

When the rotary shaft 220 passes through the bearing member 210 and is pivotally connected to the main body 110, the opposite ends of the rotary shaft 220 respectively protrude from the opposite surfaces of the main body 110. The magnetic member base 230 is affixed to one end of the rotary shaft 220, and a motor (not shown) is connected to the other end of the rotary shaft 220. Therefore, when the motor drives the rotary shaft 220 to rotate around the main axis R relative to the fixed portion 100, the magnetic member base 230 is also driven and rotates relative to the fixed portion 100.

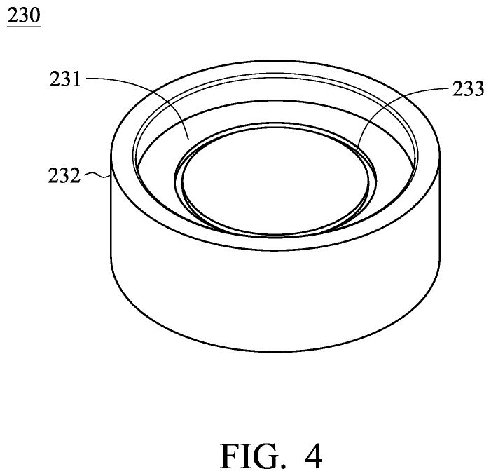

As shown in FIG. 4, the magnetic member base 230 includes a bowl structure, and has a bottom plate 231 and a lateral wall 232. The lateral wall 232 surrounds the periphery of the bottom plate 231 and extends along a direction away from the main body 110, so that an accommodating space can be formed. In this embodiment, the bottom plate 231 has a circular cross-section, and the rotary shaft 220 is connected to the center of the bottom plate 231 of the magnetic member base 230. Therefore, when the magnetic member base 230 is driven, is rotates around the main axis R. Furthermore, a glue recess 233 can be formed on the bottom plate 231.

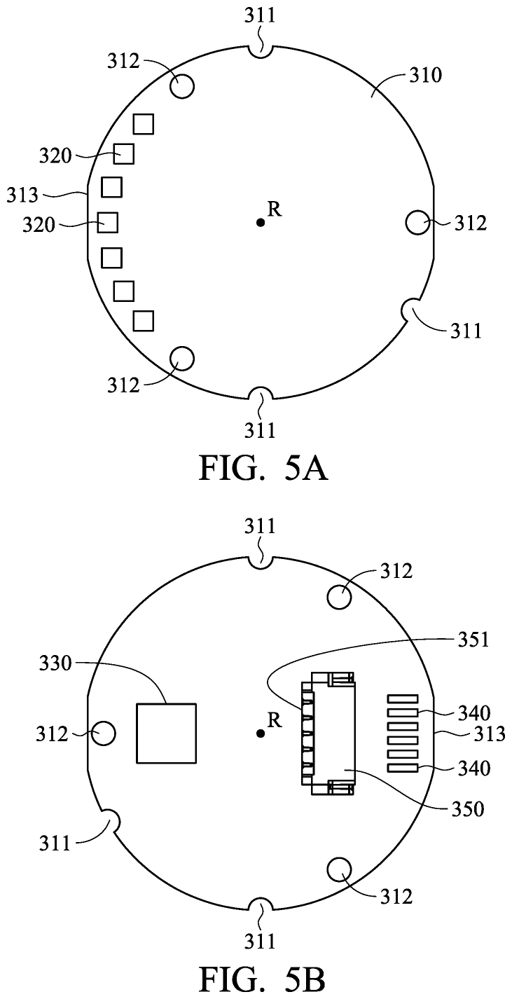

As shown in FIGS. 5A and 5B, the circuit assembly 300 includes a circuit board 310, a plurality of electronic members 320 and 330, at least one test circuit 340, and at least one connecting terminal 350. A plurality of recesses 311 are formed on the edge of the circuit board 310 and configured to engage with the fixture during assembly, loading, and testing. A plurality of connecting portions 312 are also formed on the circuit board 310. When the user desires to engage the circuit board 310 to the main body 110 of the fixed portion 100, he can correspond the supporting members 400 to the connecting portion 312, connect the main body 110 to the circuit board 310 by the supporting members 400, and pass the locking members 500 (such as the screws, the rivets, or the bolts) through the connecting portions 312 to engage with the supporting member 400 (as shown in FIG. 3). Therefore, the circuit board 310 can be steadily affixed to the main body 110.

It should be noted that, the connection lines between the connecting portions 312 can form a close pattern. This close pattern does not have rotational symmetry relative to the main axis R (that is, when the close pattern rotates less than 360 degrees, the rotated pattern is not the same as the original close pattern), so as to ensure that the circuit board 310 is in a correct connection orientation. For example, in this embodiment, the connection lines between the connecting portions 312 form an isosceles triangle. Moreover, the edge of the circuit board 310 has at least one cutting portion 313, so that the user can determine that whether the circuit board 310 is in the correct orientation during assembly.

The electronic members 320 and 330, the testing circuit 340, and the connecting terminal 350 are disposed on the circuit board 310, and electrically connected to each other. For example, the electronic members 320 and 330 can include a resistance, a capacitance, an inductance, and/or a transformer. The testing circuit 340 can be electrically connected to the external probe(s) during testing. Therefore, the testing circuit 340 can be disposed adjacent to the edge of the circuit board 310. In this embodiment, the testing circuit 340 is adjacent to the cutting portion 313. The connecting terminal 350 is electrically connected to an external electronic device (such as a computer) via an external wire, so as to transmit the data measured by the sensing module 600 to the external electronic device. It should be noted that, the electrical connecting opening 351 of the connecting terminal 350 can face the main axis R, so that the damage of the external wire due to the bending when the rotary angle detecting device P is packaged by a case can be prevented.

Referring to FIGS. 1-3, the sensing module 600 includes a magnetic member 610 and the magnetic force sensor 620. The magnetic member 610 is disposed in the accommodating space of the magnetic member base 230, and the magnetic force sensor 620 is disposed on the circuit board 310. For example, the magnetic member 610 can be affixed to the magnetic member base 230 by adhering. It should be noted that, since the glue recess 233 is formed on the bottom plate 231, even if the redundant glue is used, the glue can be filled in the glue recess 233, and the magnetic member 610 can maintain horizontal.

As seen from the direction perpendicular to the main axis R, the magnetic member 610 overlaps the lateral wall 232 of the magnetic member base 230. The position of the magnetic force sensor 620 corresponds to the position of the magnetic member 610, and can be configured to detect the rotary angle of the magnetic member 610.

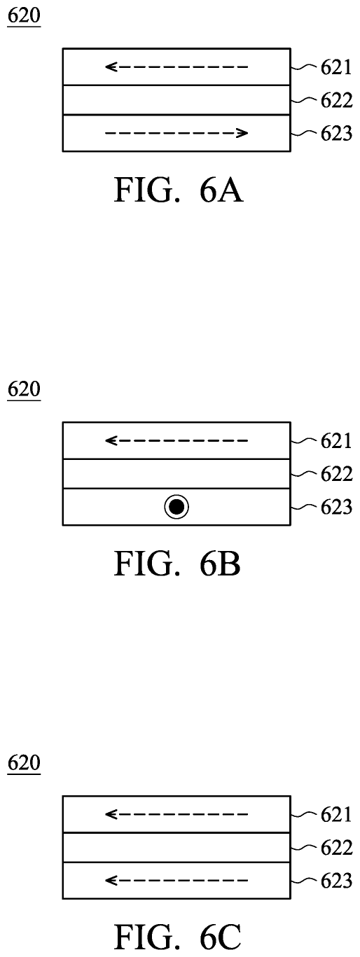

For example, as shown in FIGS. 6A-6C, the magnetic force sensor 620 can be a tunneling magnetoresistance effect sensor (TMR sensor) including a pin layer 521, an insulation layer 522, and a free layer 623. The insulation layer 622 is disposed between the pin layer 621 and the free layer 623.

The pin layer 621 can be magnetized and has a fixed magnetic field direction. The magnetic field direction of the free layer 623 can be changed according to the magnetic field direction of the external environment. When the magnetic field direction of the external environment is opposite to the magnetic field direction of the pin layer 621 (FIG. 6A), the magnetic force sensor 620 has a largest resistance. When the magnetic field direction of the external environment is different from the magnetic field direction of the pin layer 521 (FIG. 6B, the magnetic field direction is perpendicular to the paper), the resistance of the magnetic force sensor 620 is reduced. When the magnetic field direction of the external environment is the same as the magnetic field direction of the pin layer 621 (FIG. 6C), the magnetic force sensor 620 has a smallest resistance.

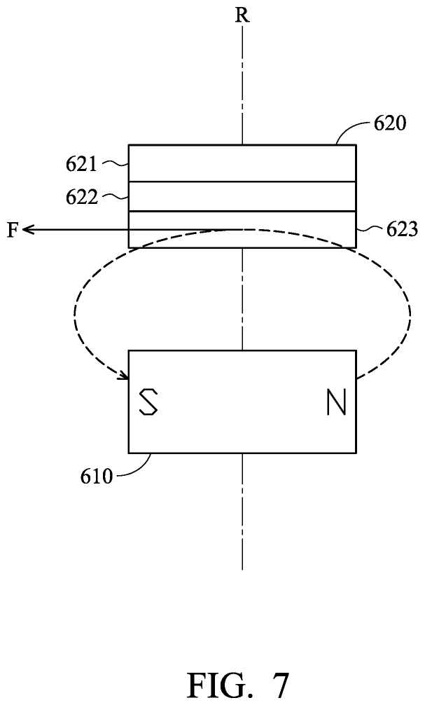

As shown in FIG. 7, in this embodiment, the magnetic pole direction of the magnetic member 610 is perpendicular to the main axis R (i.e. the magnetic field lines inside the magnetic member 610 are perpendicular to the main axis R). The magnetic force of the magnetic member 610 influences the free layer 623 of the magnetic force sensor 620, and a magnetic field direction F is therefore generated in the free layer 623. Thus, when the motor drives the rotary shaft 220, the magnetic member base 230, and the magnetic member 610 to rotate relative to the main axis R, the magnetic field direction F changes (in detail, the magnetic field direction F rotates relative to the main axis R), and the magnetic force sensor 620 can obtain the rotary angle of the rotary shaft 220, the magnetic member base 230, or the magnetic member 610.

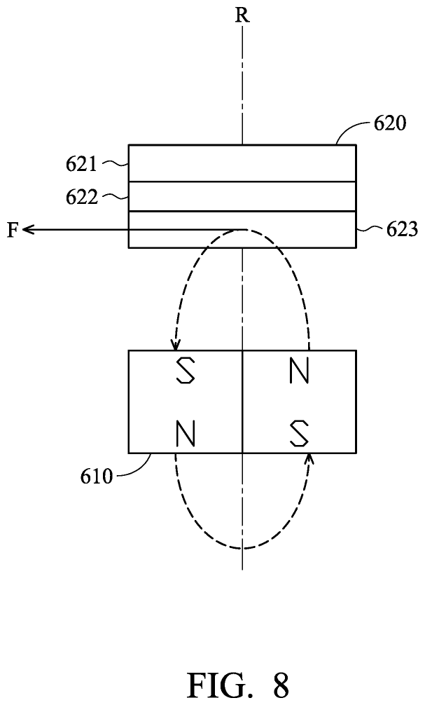

Referring to FIG. 8, in another embodiment of the invention, the magnetic member 610 can be a multipole magnet. The magnetic field lines inside the multipole magnet are parallel to the main axis R. According to this arrangement, the region with the stronger magnetic force can focus on the magnetic force sensor 620, and the magnetic field lines are more concentrated and not divergent. The electromagnetic interference can be reduced.

In some embodiment, the magnetic force sensor 620 can be a magnetoresistance effect sensor (MR sensor) or a giant magnetoresistance effect sensor (GMR sensor).

It should be noted that, in the miniaturized rotary angle detecting device P, the magnetic member 610 is close to the bearing member 210 (as shown in FIG. 3). Since the bearing member 210 includes metal, it may be magnetized, and the measurement of the magnetic force sensor 620 may be inaccurate.

Therefore, as shown in FIGS. 1-3, in this embodiment, the permeability member 700 can be disposed between the bearing member 210 and the magnetic member 610, so as to prevent the bearing member 210 from magnetizing. The permeability member 700 and the magnetic member 610 rotate simultaneously, so that the measurement of the magnetic force sensor 620 is not inaccurate even if the permeability member 700 is magnetized.

In some embodiments, the bearing member 210 is made of metal with weak permeability or non-metallic material (such as ceramics), so that the magnetization of the bearing member 210 can be further prevented.

Moreover, referring to FIG. 3, the thicknesses of the electronic members 320 and 330 in the main axis R are greater than the thickness of the magnetic force sensor 620. In the miniaturized rotary angle detecting device P, the electronic members 320 and 330 can be disposed on the periphery of the circuit board 310 or the opposite surface of the circuit board 310, so as to prevent the electronic members 320 and 330 from colliding with the magnetic member base 230 and the magnetic member 610 during rotation.

In this embodiment, the electronic member 320 and the magnetic force sensor 620 are disposed on the same surface of the circuit board 310, and the electronic member 320 is adjacent to the edge of the circuit board. As seen from the main axis R, the electronic member 320 does not overlap the magnetic force sensor 620. As seen from the direction perpendicular to the main axis R, the electronic member 320 partially overlaps the magnetic force sensor 620. The electronic member 330 and the magnetic force sensor 620 are disposed on the opposite surfaces of the circuit board 310 (that is, the circuit board 310 is disposed between the electronic member 330 and the magnetic force sensor 620), and the thickness of the electronic member 330 is greater than the thickness of the electronic member 320.

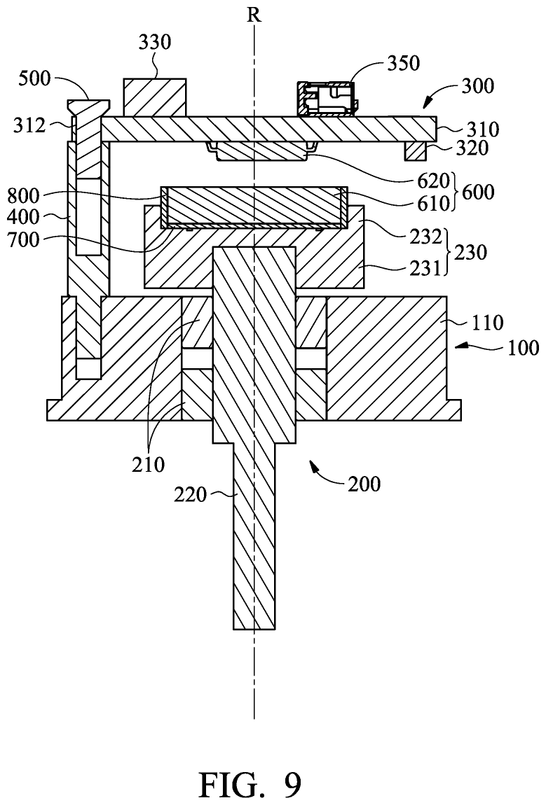

Referring to FIG. 9, in another embodiment, the rotary angle detecting device P further includes an annular additional permeability member 800, surrounding the magnetic member 610. Therefore, the reducing of the detecting accuracy due to the magnetic force of the lateral side of the magnetic member 610 can be further prevented.

In some embodiments, the magnetic member base 230 and the permeability members 700 and 800 are integrally formed as one piece. In other words, the magnetic member base 230 can be made of permeability material.

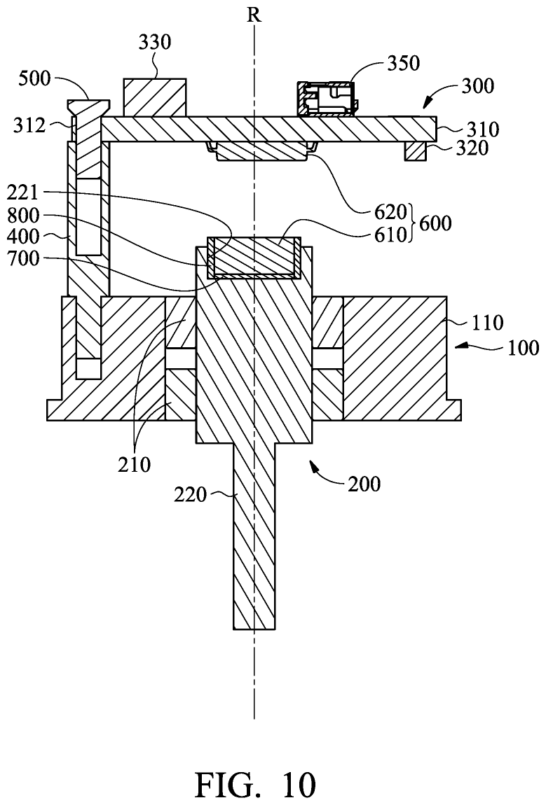

Referring to FIG. 10, in another embodiment, the rotary shaft 220 has larger dimensions and includes a depression portion 221. The magnetic member base 230 can be omitted, and the magnetic member 610 and the permeability members 700 and 800 are directly disposed in the depression portion 221 of the rotary shaft 220. The permeability members 700 and 800 are disposed between the magnetic member 610 and the rotary shaft 220. In this embodiment, the rotary shaft 220 is made of metal, so as to facilitate the motor to drive the rotary shaft 220.

In some embodiments, the rotary shaft 220 is made of metal with weak permeability or non-metallic material (such as ceramics).

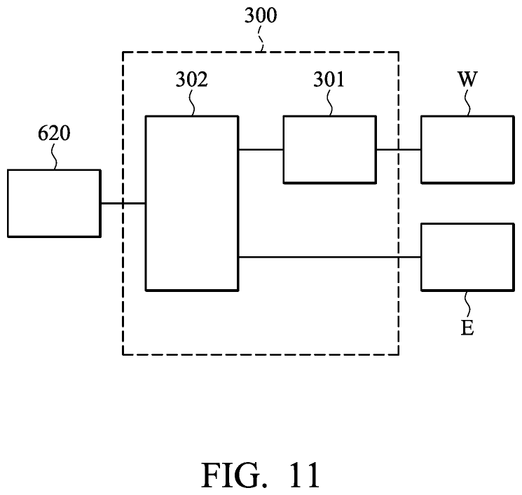

FIG. 11 is a circuit connection schematic diagram of the circuit assembly 300, the magnetic force sensor 620, and external components in the aforementioned embodiments. As shown in the figure, an external power source W is electrically connected to the circuit assembly 300 via the connecting terminal 350 to provide the power to the circuit assembly 300. A fuse unit 301 can be disposed between a processor unit 302 and the external power source W. When an abnormal current flows through the fuse unit 301, the fuse unit 301 can interrupt the electrical connection of the external power source W, so as to protect the circuit assembly 300.

The data detected by the magnetic force sensor 620 can transmit to the processor unit 302. The processor unit 302 can transform the aforementioned data to a required code (such as a waveform), and the code can be transmitted to the external electronic device E.

In summary, a rotary angle detecting device is provided, including a fixed portion, a rotary module, a sensing module, and a permeability member. The rotary module includes a rotary shaft pivotally connected to the fixed portion, and can rotate around a main axis relative to the fixed portion. The sensing module is configured to detect the motion state of the rotary shaft relative to the fixed portion. The sensing module includes a magnetic force sensor and a magnetic member corresponding to the magnetic force sensor. The magnetic member can rotate relative to the magnetic force sensor. The permeability member is disposed between the sensing module and the rotary module.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A rotary angle detecting device, comprising:
a fixed portion;
a rotary module, comprising a rotary shaft, wherein the rotary shaft is pivotally connected to the fixed portion, and the rotary module can rotate around a main axis relative to the fixed portion;
a sensing module, configured to detect the motion state of the rotary shaft relative to the fixed portion, wherein the sensing module comprises:
a magnetic force sensor; and
a magnetic member, corresponding to the magnetic force sensor,
wherein the magnetic member can rotate relative to the magnetic force sensor; and
a permeability member, disposed between the sensing module and the rotary module.

2. The rotary angle detecting device as claimed in claim 1, wherein the rotary module further comprises a bearing member disposed on the fixed portion, and the shaft axis is pivotally connected to the fixed portion via the bearing member.

3. The rotary angle detecting device as claimed in claim 2, wherein the bearing member is made of metal with weak permeability or non-metallic material.

4. The rotary angle detecting device as claimed in claim 2, wherein the permeability member is disposed between the bearing member and the magnetic force sensor.

5. The rotary angle detecting device as claimed in claim 1, wherein the magnetic member is disposed between the magnetic force sensor and the permeability member.

6. The rotary angle detecting device as claimed in claim 1, wherein the rotary module further comprises a magnetic member base affixed to the rotary axis, and the magnetic member is disposed on the magnetic member base.

7. The rotary angle detecting device as claimed in claim 6, wherein as seen from a direction perpendicular to the main axis, the magnetic member base and the magnetic member at least partially overlap.

8. The rotary angle detecting device as claimed in claim 7, wherein the permeability member and the magnetic member base are integrally formed as one piece.

9. The rotary angle detecting device as claimed in claim 1, wherein the rotary angle detecting device further comprises an additional permeability member surrounding the magnetic member.

10. The rotary angle detecting device as claimed in claim 1, wherein the magnetic field lines inside the magnetic member are perpendicular to the main axis.

11. The rotary angle detecting device as claimed in claim 1, wherein the magnetic member is a multipole magnet, and the magnetic field lines inside the magnetic member are parallel to the main axis.

12. The rotary angle detecting device as claimed in claim 1, wherein the rotary angle detecting device further comprises:
a circuit assembly, comprising a plurality of connecting portions; and
a plurality of supporting members, corresponding to the connecting portions, and connecting the fixed portion to the circuit assembly, wherein the connection lines between the connecting portions form a close pattern, and the close pattern does not have rotational symmetry relative to the main axis.

13. The rotary angle detecting device as claimed in claim 12, wherein the circuit assembly comprises a circuit board, and the circuit board has a cutting portion and a plurality of testing circuits, wherein at least one testing circuit is adjacent to the cutting portion.

14. The rotary angle detecting device as claimed in claim 12, wherein the circuit assembly comprises a connecting terminal, and an electrical connecting opening of the connecting terminal faces the main axis.

15. The rotary angle detecting device as claimed in claim 12, wherein the circuit assembly comprises a circuit board and at least one electronic member, the magnetic force sensor and the electronic member are disposed on the circuit board, and the circuit board is disposed between the magnetic force sensor and the electronic member, wherein the thickness of the electronic member is greater than the thickness of the magnetic force sensor.

16. The rotary angle detecting device as claimed in claim 12, wherein the circuit assembly comprises a circuit board and at least one electronic member, and the magnetic force sensor and the electronic member are disposed on the same surface of the circuit board, wherein the thickness of the electronic member is greater than the thickness of the magnetic force sensor, and the electronic member and the magnetic member do not overlap as seen from the axis.

17. The rotary angle detecting device as claimed in claim 16, wherein as seen from a direction perpendicular to the main axis, the electronic member and the magnetic member at least partially overlap.

18. The rotary angle detecting device as claimed in claim 2, wherein the circuit assembly comprises a circuit board, and a plurality of recesses are formed on the edge of the circuit board.

19. The rotary angle detecting device as claimed in claim 1, wherein the rotary shaft further comprises a depression portion, and at least a portion of the magnetic member is disposed in the depression portion.

20. The rotary angle detecting device as claimed in claim 19, wherein the rotary shaft is made of metal with weak permeability or non-metallic material.

21. The rotary angle detecting device as claimed in claim 19, wherein the rotary shaft is made of metal, and the permeability member is disposed between the magnetic member and the rotary shaft.
